(19) United States
(12) Patent Application Publication
(10) Pub. No.: US 2006/0266147 A1
(43) Pub. Date: Nov. 30, 2006

(54) Shifter assembly for manual transmission

(76) Inventors: Thomas Christopher Bowen, Rochester Hills, MI (US); Marius Octavel Enache, LaSalle (CA); Dan Mircea Stefan, Windsor (CA); Young Soo Kim, Seosan City (KR)

Correspondence Address: PURDUE LAW OFFICES;2735 N. HOLLAND-SYLVANIA ROAD, SUITE B-2, TOLDEO, OH, 43615, US

(21) Appl. No.: 11/139,721

(22) Filed: May 27, 2005

(51) Int. Cl. F16H 59/04

(52) U.S. Cl. 74/473.1; 74/473.28

(57) ABSTRACT

A shifter assembly for a manual transmission includes a pair of rails extending axially and a plurality of forks operatively cooperating with the rails. Each of the rails has one of the forks being fixed thereto and one of the forks being movable relative thereto.

### BACKGROUND OF THE INVENTION

1. Field of the Invention

The present invention relates generally to manual transmissions and, more particularly, to a shifter assembly for a manual transmission of a vehicle.

2. Description of the Related Art

It is known to provide a manual transmission for a vehicle such as a truck. The manual transmission typically includes a shifting device to shift a plurality of gears therein. An example of such a shifting device is disclosed in U.S. Pat. No. 5,477,742. In that patent, a gear-shift device for a change-speed gear box has a selector shaft that acts via inclined surfaces and reaction balls on a reaction sleeve acted upon by an orientation spring. This arrangement makes it possible to feel a working point when a first shift gate is selected and to allow a spring force to be supported directly on a housing via the reaction balls when a second shift gate is selected.

One disadvantage of above-patented shifting device is that inclined surfaces and reaction balls are used. Another disadvantage of such a shifting device is that four shift bars or rails are required. Yet another disadvantage of such a shifting device is that it requires numerous parts, requires a blind assembly, and is relatively costly.

Therefore, it is desirable to provide a new shifter assembly for a manual transmission of a vehicle. It is also desirable to provide a shifter assembly for a manual transmission that reduces the number of parts and cost. It is further desirable to provide a shifter assembly that eliminates blind assembly of springs. Therefore, there is a need in the art to provide a shifter assembly for a manual transmission that meets these desires.

### SUMMARY OF THE INVENTION

Accordingly, the present invention is a shifter assembly for a manual transmission. The shifter assembly includes a pair of rails extending longitudinally. The shifter assembly also includes a plurality of forks. At least one fork is fixed to one of the rails and at least one fork is movable relative to the one of the rails.

One advantage of the present invention is that a new shifter assembly is provided for a manual transmission that reduces the number of parts because it has only one pair of shift rails. Another advantage of the present invention is that the shifter assembly eliminates inclined surfaces and reaction balls. Yet another advantage of the present invention is that the shifter assembly eliminates blind assembly of springs. Still another advantage of the present invention is that the shifter assembly has only one shift fork moving at a time. A further advantage of the present invention is that the shifter assembly is less costly.

Other features and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a plan view of a shifter assembly, according to the present invention.

FIG. 2 is an elevational view of the shifter assembly of FIG. 1.

FIG. 3 is a sectional view taken along line 3-3 of FIG. 1.

FIG. 4 is a sectional view taken along line 4-4 of FIG. 3.

FIG. 5 is a view similar to FIG. 4 illustrating a reverse position.

FIG. 6 is a view similar to FIG. 4 illustrating a 5-6 position.

FIG. 7 is a sectional view taken along line 7-7 of FIG. 5.

FIG. 8 is a sectional view taken along line 8-8 of FIG. 2.

FIG. 8A is an enlarged view of a portion in circle 8A of FIG. 8.

FIG. 9 is a sectional view taken along line 9-9 of FIG. 8.

### DESCRIPTION OF THE PREFERRED EMBODIMENT(S)

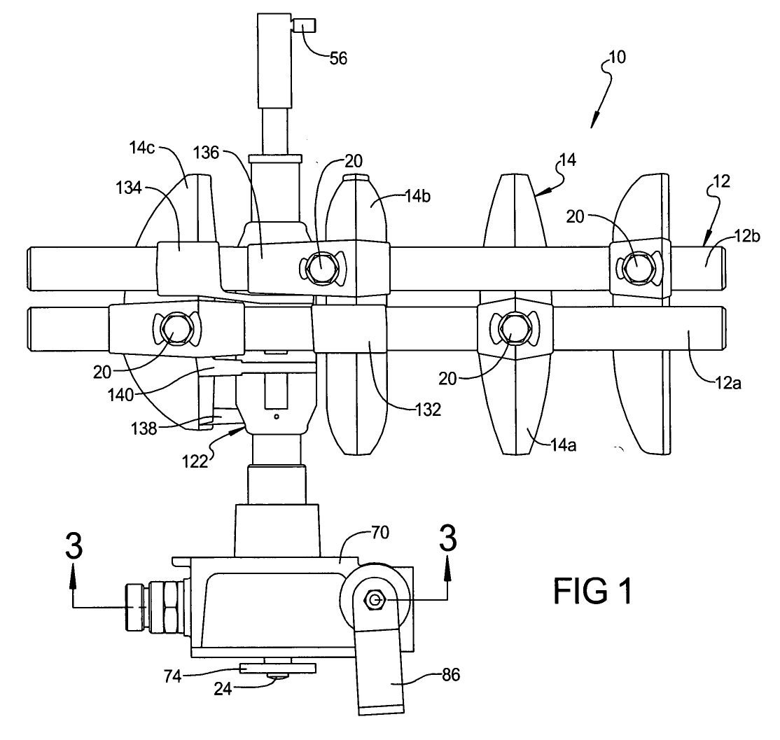

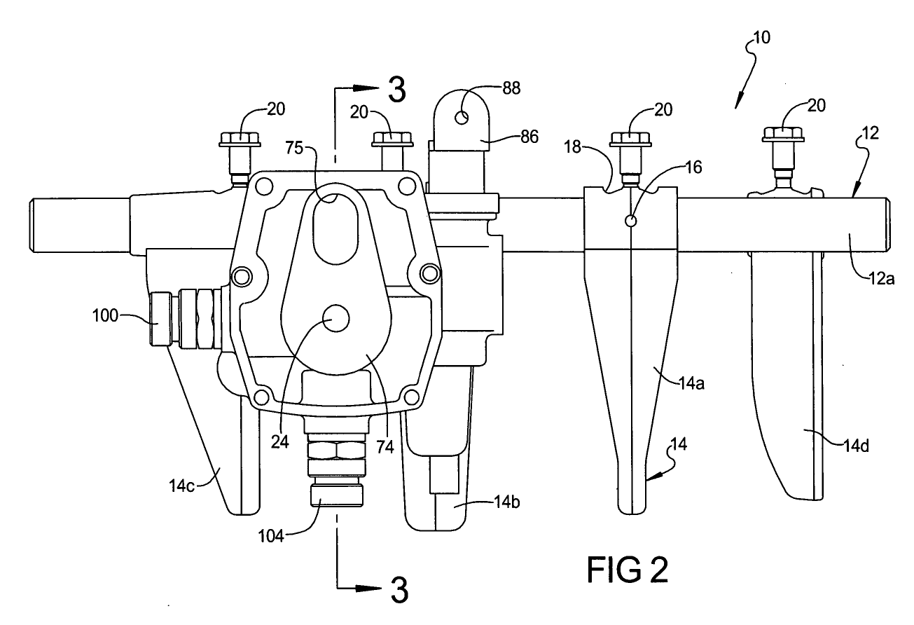

Referring to the drawings and in particular FIGS. 1 and 2, one embodiment of a shifter assembly 10, according to the present invention, is shown for a manual transmission (not shown). The shifter assembly 10 includes a at least one, preferably a pair of rails, generally indicated at 12. Each of the rails 12 extends axially and has a generally circular cross-sectional shape. The rails 12 are made of metal material. The rails 12 are spaced and orientated generally parallel to each other. In the embodiment illustrated, the rails 12 include a first rail 12a and a second rail 12b.

The shifter assembly 10 also includes a plurality of forks, generally indicated at 14, operatively cooperating with the rails 12. Each of the forks 14 extend radially and have a generally inverted “U” shape. The forks are made of a metal material such as cast steel. The forks 14 include a first fork 14a, second fork 14b, third fork 14c, and a fourth fork 14d. The first fork 14a is a 1-2 shift fork. The second fork 14b is a 3-4 shift fork. The third fork 14c is a 5-6 shift fork. The fourth fork 14d is a reverse shift fork. Each of the shift forks 14 cooperates with synchronizers (not shown) to manual shift gears (not shown) in the transmission. In the embodiment illustrated, each of the rails 12 includes at least two of the forks 14. As illustrated, the first fork 14a is fixedly connected to the first rail 12a and the fourth fork 14d is fixedly connected to the second rail 12b by a suitable mechanism such as a pin 16. Also, the second fork 14b is movably or slidably connected to the first rail 12a and the third fork 14c is movably or slidably connected to the second rail 12b by catchers to be described.

Each of the forks 14 includes at least one, preferably a plurality of recesses 18 on an upper end thereof. The shifter assembly 10 also includes at least one, preferably a plurality of indexes 20. Each of the indexes 20 is generally cylindrical in shape. Each of the indexes 20 is connected to a transmission housing (not shown). One of the indexes 20 cooperates with one of the forks 14. Each of the indexes 20 extends into one of the recesses 18 of the forks 14. It should be appreciated that the indexes 20 provide a mechanical feel to the operator when shifting the shifter assembly 10.

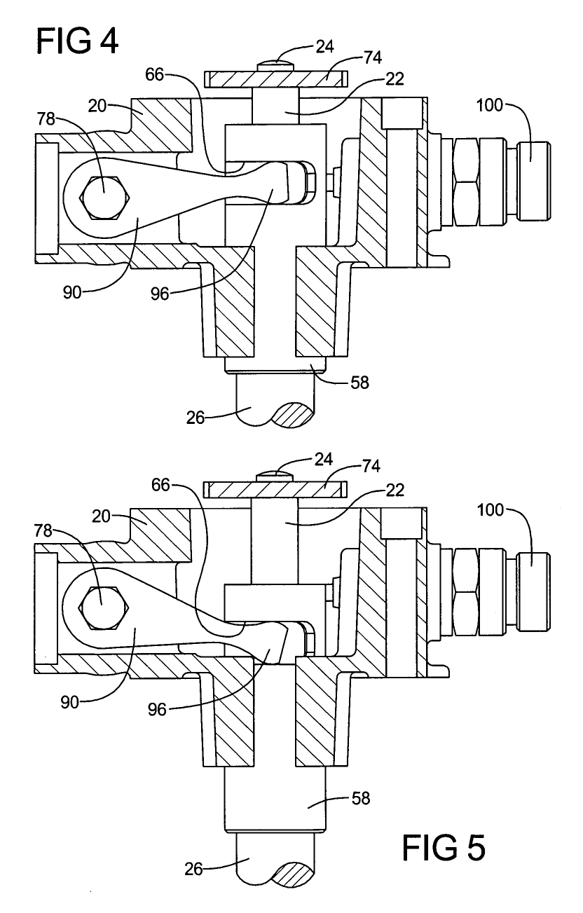

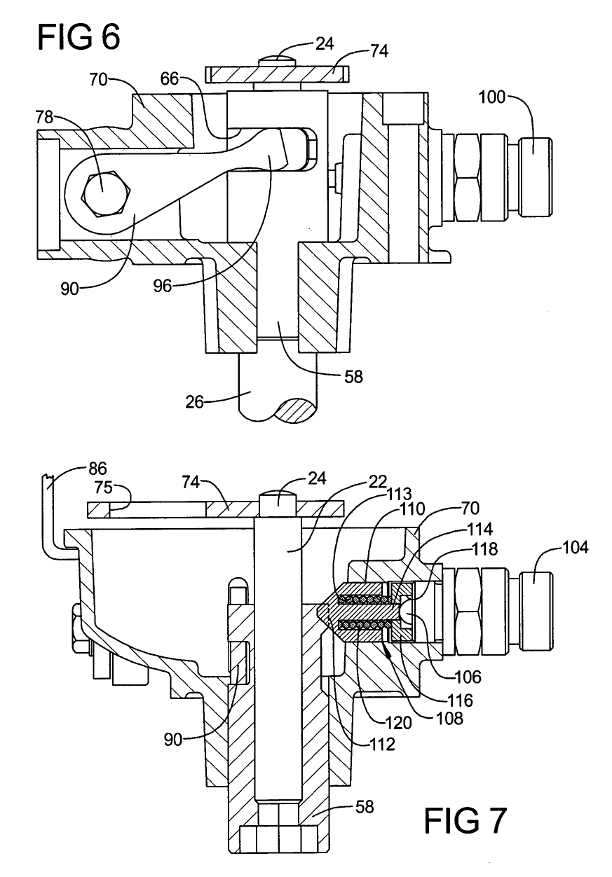

Referring to FIGS. 1 through 8, the shifter assembly 10 includes a shifter shaft 22. The shifter shaft 22 extends axially and is generally cylindrical in shape with a generally circular cross-sectional shape. The shifter shaft 22 is made of a metal material. The shifter shaft 22 is orientated generally perpendicular to the rails 12. The shifter shaft 22 has a reduced diameter portion 24 at one end for a function to be described.

The shifter assembly 10 includes a selector shaft 26 connected to the shifter shaft 22 by a suitable mechanism such as welding. The selector shaft 26 extends axially and is generally tubular in shape with a generally circular cross-sectional shape. The selector shaft 26 is made of a metal material. The selector shaft 26 has a passageway 28 extending axially therethrough with a first enlarged portion 30 to receive one end of the shifter shaft 22 and a second enlarged portion 32 to receive a nut 52 to be described. The selector shaft 26 includes at least one, preferably a plurality of, more preferably three actuators 33 extending radially from an outer surface therefrom and spaced axially for a function to be described. In the embodiment illustrated, two of the actuators 33 are located on an upper portion of the selector shaft 26 and the other one of the actuators 33 is located on a lower surface of the selector shaft 26.

The shifter assembly 10 also includes a return spring assembly, generally indicated at 34, connected to the selector shaft 26. The return spring assembly 34 includes a shaft 36. The shaft 36 extends axially and is generally cylindrical in shape with a generally circular cross-sectional shape. The shaft 36 is made of a metal material. The shaft 36 has a first end portion 38 extending axially, a middle portion 40 extending axially from the first end portion 38 and having a reduced diameter than the first end portion 38, and a second end portion 42 extending axially from the middle portion 40 and having a reduced diameter than the middle portion 40. The middle portion 40 is partially disposed in the enlarged end portion 32 of the selector shaft 26 and the second end portion 42 is slidably disposed in the passageway 28 of the selector shaft 26.

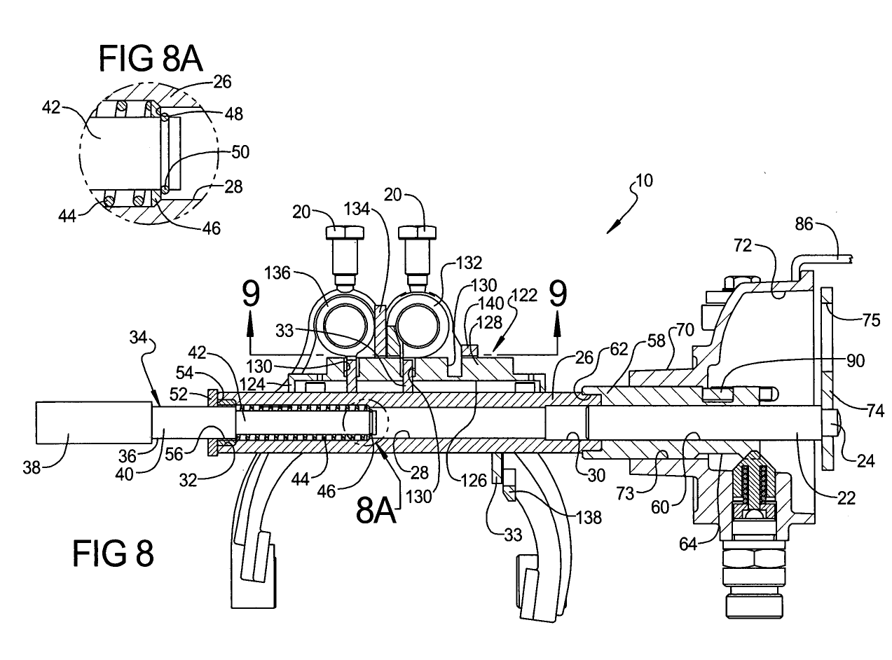

Referring to FIGS. 8 and 8A, the return spring assembly 34 includes a spring 44 to urge the shaft 36 axially away from the selector shaft 26. The spring 44 is of a coil type. The spring 44 is disposed in the passageway 28 and about the second end portion 42 of the shaft 36. The spring 44 is also disposed between the middle portion 40 of the shaft 36 and a stop member 46 disposed about the end of the second end portion 42 of the shaft 36 as illustrated in FIG. 8A. The stop member 46 is generally annular and cooperates with a shoulder 48 of the passageway 28 to limit the travel of the shaft 36 in the passageway 28. The stop member 46 is retained on the shaft 36 by a retainer 50 disposed about the second end portion 42 of the shaft 36.

The return spring assembly 34 further includes a nut 52 to close the enlarged end portion 32 of the passageway 28 of the selector shaft 26. The nut 52 has a threaded portion 54 to threadably engage the enlarged end portion 32 to be secured therein. The nut 52 also has an aperture 54 extending axially therethrough to allow the shaft 36 to extend through the nut 52. It should be appreciated that the return spring assembly 34 may include a screw 56 (FIG. 1) threadably engaging the first end portion 38 of the shaft 36 for connection to a transmission housing (not shown). It should also be appreciated that the return spring assembly 34 centers the shift lever in the middle when released.

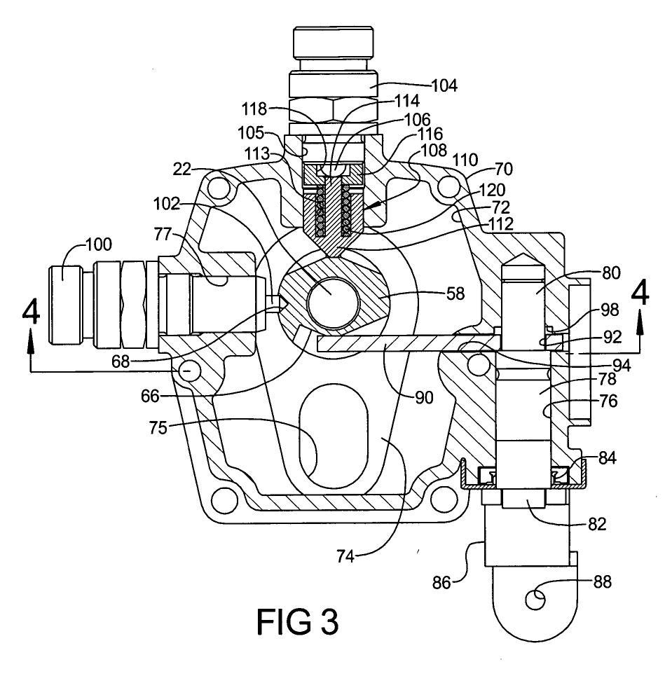

Referring to FIGS. 3 through 8, the shifter assembly 10 includes a cam member 58 connected to the selector shaft 26 by a suitable mechanism such as welding. The cam member 58 extends axially and is generally cylindrical in shape with a generally circular cross-sectional shape. The cam member 58 is made of a metal material. The cam member 58 has a passageway 60 extending axially therethrough to receive a portion of the shifter shaft 22. The passageway 60 has an enlarged end portion 62 to receive one end of the selector shaft 26. The cam member 58 has a first cam groove 64 extending axially along a portion of an outer periphery thereof for a function to be described. The cam member 58 also has a second cam groove 66 extending radially along a portion of an outer periphery thereof for a function to be described. The cam member 58 further has a third cam groove 68 extending along a portion of an outer periphery thereof for a function to be described.

The shifter assembly 10 also includes a shifter housing 70 disposed about the cam member 58 and axially along a portion thereof. The housing 70 is generally rectangular in shape, but may have any suitable shape. The housing 70 is made of a metal material. The housing 70 has a first cavity 72 extending axially therein and an aperture 73 extending axially therethrough and communicating with the first cavity 72. The cam member 58 extends through the aperture 73 and into the first cavity 72. The shifter shaft 22 extends through the cam member 58 and the first cavity 72. The shifter assembly 10 further includes a lever 74 disposed outside of the first cavity 72 and connected to the end 24 of the shifter shaft 22 by a suitable mechanism such as welding to rotate the shifter shaft 22 for a function to be described. The lever 74 also has an aperture 75 extending therethrough for connection to an air shift assist mechanism (not shown). The housing 50 also includes a second cavity 76 extending radially therein for a function to be described. The housing 70 further includes an aperture 77 extending diametrically therein and communicating with the first cavity 72 for a function to be described.

The shifter assembly 10 includes a selector cable shaft 78 disposed in the second cavity 76. The selector cable shaft 78 extends axially and is generally cylindrical in shape with a generally circular cross-sectional shape. The cable shaft 78 is made of a metal material. The cable shaft 78 has a first end portion 80 extending axially and having a reduced diameter disposed in the second cavity 76 and a second end portion 82 extending axially and having a reduced diameter disposed outside of the second cavity 76.

The shifter assembly 10 includes a seal 84 to seal the second cavity 76. The seal 84 is generally annular and is disposed about the cable shaft 78. The seal 84 is connected to the housing 70 by a suitable mechanism such as a press-fit. The shifter assembly 10 includes a lever 86 disposed outside of the second cavity 74 and is connected to the end 82 of the cable shaft 78 by a suitable mechanism such as welding to rotate the cable shaft 78 for a function to be described. The lever 86 also has an aperture 88 extending therethrough for connection to a cable (not shown).

The shifter assembly 10 also includes a selector shaft actuation lever 90 cooperating with the cable shaft 78 and the cam member 58. The actuation lever 90 extends axially and is generally planar in shape. The actuation lever 90 has an aperture 92 extending through one end thereof to be disposed about the cable shaft 78. The actuation lever 90 extends through a slot 94 in the housing 70 and has a reduced end 96 that is disposed in the groove 66 of the cam member 58. The shifter assembly 10 further includes a shim 98 disposed about the cable shaft 78 and between the housing 70 and the actuation lever 90 to support the actuation lever 90 in the slot 94.

The shifter assembly 10 includes a neutral switch 100 cooperating with the cam member 58. The neutral switch 100 extends through the aperture 77 and has a moveable end 102 disposed in the groove 68 of the cam member 58. The neutral switch 100 is electrically connected to a controller (not shown) to signal when the shifter assembly 10 is in a neutral position. It should be appreciated that the neutral switch 100 is threadably secured to the housing 70. It should also be appreciated that the neutral switch 100 is conventional and known in the art.

The shifter assembly 10 also includes a reverse switch 104 operatively cooperating with the cam member 58. The reverse switch 104 extends through an aperture 105 in the housing 70 and has a moveable end 106 cooperating with a reverse return spring assembly 108 to be described. The reverse switch 104 is electrically connected to a controller (not shown) to signal when the shifter assembly 10 is in a reverse position. It should be appreciated that the reverse switch 104 is threadably secured to the housing 70. It should also be appreciated that the reverse switch 104 is conventional and known in the art.

The shifter assembly 10 includes a reverse return spring assembly, generally indicated at 108. The reverse return spring assembly 108 includes a cap 110 disposed in the aperture 105. The cap 110 extends axially and is generally cylindrical in shape with a generally circular cross-sectional shape. The cap 110 has an end 112 that is generally “V” shaped to cooperate with the cam groove 64. The cap 110 also has an annular recess 113 extending axially therein to form a post 114. The cap 110 is made of a metal material. The cap 110 is integral, unitary, and one-piece.

The reverse return spring assembly 108 also includes a spacer 116 disposed at one end of the cap 110. The spacer 116 is generally annular with a generally “U” cross-sectional shape. The spacer 116 is made of a metal material. The spacer 116 is disposed about one end of the post 114 of the cap 110 and has a recess 118 to receive the moveable end 106 of the reverse switch 104.

The reverse return spring assembly 108 further includes a spring 120 to urge the cap 110 away from the spacer 116. The spring 120 is of a coil type. The spring 120 is disposed about the post 114 in the recess 113 between the spacer 116 and the cap 110. It should be appreciated that the spring 120 provides more effort for actuation into a reverse position for the shifter assembly 10.

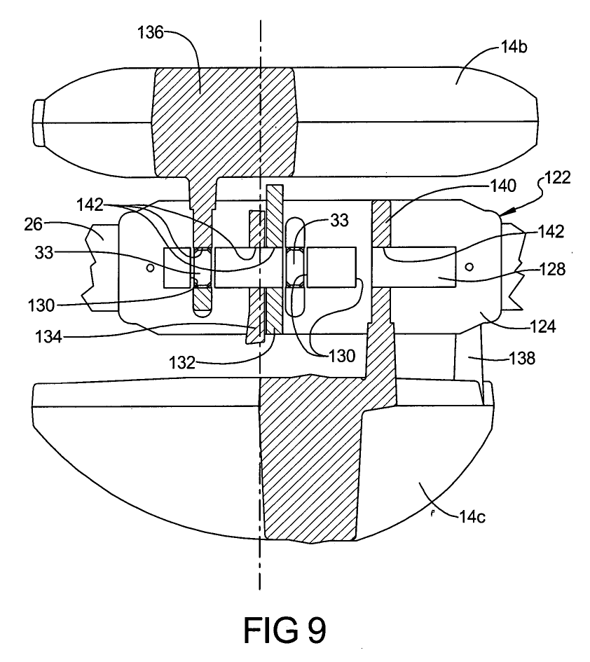

Referring to FIGS. 1, 2, 8, and 9, the shifter assembly 10 includes an interlock assembly, generally indicated at 122. The interlock assembly 122 includes an interlock member 124 extending axially and having a generally rectangular shape. The interlock member 124 is made of metal material. The interlock member 124 has a cavity 126 extending into a bottom surface thereof. The interlock member 124 has a rail portion 128 extending from an upper surface thereof. The rail portion 128 extends axially and is generally rectangular in shape. The rail portion 128 has at least one, preferably a plurality of slots 130 spaced axially therealong for a function to be described. The slots 130 cooperate with the actuators 33 extending from the selector shaft 26. It should be appreciated that the interlock assembly 122 allows only fork 14 to move at a time.

The shifter assembly 10 also includes a first catcher 132 connected to the first rail 12a for cooperating with the actuators 33 and the interlock member 124. The first catcher 132 is for the 1-2 fork, which is the first fork 14a. The shifter assembly 10 includes a second catcher 134 connected to the second rail 12b for cooperating with the actuators 33 and the interlock member 124. The second catcher 134 is for the reverse fork, which is the fourth fork 14d. The shifter assembly 10 also includes a third catcher 136 connected to the second fork 14b and disposed about the second rail 12b for cooperating with the actuators 33 and the interlock member 124 and for sliding movement along the second rail 12b. The third catcher 136 is for the 3-4 fork. The shifter assembly 10 further includes a fourth catcher 138 connected to the third fork 14c and a fifth catcher 140 connected to the third fork 14c. The fourth catcher 138 and fifth catcher 140 are disposed about the first rail 12a for cooperating with the actuators 33 and the interlock member 124 and for sliding movement along the first rail 12a. The fourth catcher 138 and fourth catcher 140 are for the 5-6 fork. It should be appreciated that each of the catchers 132, 134, 136, 138, and 140 has a slot that cooperates with the actuators 33 and the rail portion 128 of the interlock member 124.

In operation, a cable (not shown) is actuated to move the lever 86, in turn, rotating the actuation lever 90 to move the cam member 58 and selector shaft 26 axially to a position such that one of the actuators 33 is aligned with one of the catchers 132, 134, 136, 138, and 140. When this occurs, the air shift assist mechanism rotates the lever 74, in turn, rotating the shifter shaft 22, selector shaft 26, and the actuators 33 to move the aligned one of the catchers 132, 134, 136, 138, and 140, thereby engaging the corresponding shift fork 14 with the synchronizer (not shown) to shift the transmission. Simultaneously, the rail portion 128 of the interlock member 124 prevents the catchers 132, 134, 136, 138, and 140 not selected from being moved. As such, only one fork 14 is engaged with its corresponding synchronizer.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

What is claimed is:

1. A shifter assembly for a manual transmission comprising:
a pair of rails extending axially;
a plurality of forks operatively cooperating with said rails; and
each of said rails having one of said forks being fixed thereto and one of said forks being movable relative thereto.

2. A shifter assembly as set forth in claim 1 wherein said rails comprise a first rail and a second rail.

3. A shifter assembly as set forth in claim 2 wherein said first rail and said second rail extend generally parallel to each other.

4. A shifter assembly as set forth in claim 2 wherein said forks comprise a first fork, a second fork, a third fork, and a fourth fork.

5. A shifter assembly as set forth in claim 4 wherein said first fork is fixed to said first rail.

6. A shifter assembly as set forth in claim 4 wherein said second fork is movably attached to said first rail.

7. A shifter assembly as set forth in claim 4 wherein said third fork is fixed to said second rail.

8. A shifter assembly as set forth in claim 4 wherein said fourth fork is movable attached to said second rail.

9. A shifter assembly as set forth in claim 4 wherein said first fork is a 1-2 gear shift fork.

10. A shifter assembly as set forth in claim 4 wherein said second fork is a 3-4 gear shift fork.

11. A shifter assembly as set forth in claim 4 wherein said third fork is a reverse gear shift fork.

12. A shifter assembly as set forth in claim 4 wherein said fourth fork is a 5-6 gear shift fork.

13. A shifter assembly as set forth in claim 1 including a shifter shaft extending axially and a selector shaft extending axially from said shifter shaft.

14. A shifter assembly as set forth in claim 13 including a plurality of actuators extending outwardly from said selector shaft.

15. A shifter assembly as set forth in claim 13 including a housing disposed about said shifter shaft.

16. A shifter assembly as set forth in claim 13 including an interlock assembly operatively supported by said selector shaft to operatively cooperate with said forks.

17. A shifter assembly as set forth in claim 13 including a reverse return spring assembly to operatively cooperate with said selector shaft.

18. A shifter assembly as set forth in claim 13 including a selector shaft actuation lever pivotally connected to said housing.

19. A shifter assembly as set forth in claim 13 including a return spring assembly cooperating with said selector shaft.

20. A shifter assembly as set forth in claim 19 wherein said return spring assembly comprises a shaft, a spring, and a nut.
